(19) United States
(12) Patent Application Publication
(10) Pub. No.: US 2006/0215805 A1
(43) Pub. Date: Sep. 28, 2006

(54) Sealing device for the outer surface of a nuclear fuel cladding

(76) Inventors: Louis Aerts, Mol (BE); Alain Vandergheynst, Dour (BE); Jean Heylen, Mol (BE)

Correspondence Address: SUGHRUE MION, PLLC, 2100 PENNSYLVANIA AVENUE, N.W., SUITE 800, WASHINGTON, DC, 20037, US

(21) Appl. No.: 10/595,097

(22) PCT Filed: Aug. 13, 2003
(86) PCT No.: PCT/BE03/00135

§ 371 Date: Feb. 10, 2006

(51) Int. Cl. G21C 21/02

(52) U.S. Cl. 376/409

(57) ABSTRACT

Sealing device (10) between two media and the outer surface of a fuel cladding (1), characterized by three states: a state retracted for contactiess axial insertion of said fuel cladding (1) though the sealing device, a state statically hermetically sealed around said fuel cladding maintained at rest, and a state dynamically hermetically sealed around said fuel cladding under axial and/or rotational movement.

### BACKGROUND

The present invention relates to a sealing device between two media and the outer surface of a nuclear fuel cladding.

1. Field of the Invention

Such device is currently used for sealing the penetration of a fuel cladding into a contaminated enclosure possibly maintained at negative pressure preventing spread of contamination to the process rooms or to the environment. Consequently, the part of the fuel cladding that is not engaged into the enclosure remains contamination free what avoids a necessary subsequent cumbersome decontamination process. To avoid contamination release towards the environment, the tightness has to be insured at any time.

This device is also used for sealing the penetration of a fuel cladding into a process enclosure. A process enclosure is here defined as an enclosure where a given atmosphere has to be established and maintained for process operation. As it is assumed that this process enclosure is not contaminated, the tightness of the enclosure is only requested for the duration of the process performances. If, however, the process enclosure has to remain tight between two consecutive process operations or if the process operations occur in a contaminated environment, the tightness of the process enclosure has to be insured at any time as well as for a contaminated enclosure.

The fabrication of nuclear fuel rods, in particular the fabrication of mixed oxide (MOX) fuel rods, involves several operations that are hereafter listed. Most of these operations involving handling of nuclear materials are usually performed in enclosures that protect the outside environment and the operators against the effects of α, β, and γ emitters contained in the nuclear materials.

An indicative operation sequence for fabricating nuclear fuel rods is:
insertion of a fuel cladding usually fitted with a first end plug,
penetration of this fuel cladding into the enclosure containing the nuclear material,
loading of the nuclear material (pellets) into the fuel cladding,
loading of a fuel compression spring or other inserts,
replacement of the cladding inner gas (i.e. air or nitrogen) by an inert gas (sometimes before pellet loading),
decontamination of the open end cladding zone,
insertion of the second (top) end plug,
welding of this second end plug onto the cladding,
possible rod pressurization,
decontamination and control of the fuel cladding part that has been inserted into the enclosure(s).

To avoid the decontamination and the control of the whole fuel cladding length, only the smallest possible portion is inserted into the contaminated medium or enclosure. This requests the presence of a sealing device at the penetration of the fuel cladding in the contaminated enclosure(s). This sealing device must allow an axial movement of the fuel cladding to present the front part of the fuel cladding to all necessary fabrication steps (pellet loading, spring insertion, gas evacuation and refill, welding of the second end plug). This last operation also requests a rotation of the fuel cladding to perform the girth weld by presenting the weld bead in front of the welding electrode.

The above operation sequence assumes that the fuel cladding is already fitted with a first welded end plug. A similar sealing device may also be useful, as an example, for welding this first end plug onto the fuel cladding. Indeed the welding operations of said first plug onto the fuel cladding have to be performed under controlled atmosphere to insure the necessary weld quality. To avoid using very large welding enclosures containing the whole fuel cladding length, only the bottom end of the fuel cladding is inserted into the process enclosure while a provisional plug closes the inner volume of the fuel cladding at its opposite end. This procedure requests the presence of a sealing device at the penetration of the fuel cladding in the process enclosure. This sealing device must allow a rotation of the fuel cladding to perform the girth weld and usually also an axial movement to put the fuel cladding end in the right position.

2. Prior Art

The leak tightness of a fuel cladding with respect to an enclosure is usually obtained by a system based on seals that are widely used in the industry, (e.g. O-Rings, Quad-Rings, . . . ). These seals are generally made out of an elastomer material.

The U.S. Pat. No. 4,748,798 patent addresses the problem of insuring a tight connection of a fuel cladding with an enclosure by providing a device comprising a deformable annular member inflated to be hermetically seated onto the fuel cladding.

As it is conceived, i. e. with a deformable annular member that is inflated to be seated onto the fuel cladding, the sealing device has several drawbacks.

The inner diameter of the deformable annular member must be somewhat larger than the outer diameter of the fuel cladding to allow a contactless introduction into the sealing device. One must indeed take into account the dimensional tolerances of said fuel cladding as well as some margins meant to cope with a possible misalignment of the fuel cladding centerline with respect to that of the deformable annular member.

If the inner seal diameter is not large enough, the edge of the fuel cladding that has a sharp profile may damage the inner seal surface generating subsequent early leakages. Leaks may lead to non-conform fuel products or to contamination of the operator or contamination of the environment or both. Frequent replacements of the seal lead to production losses, costs and contamination release risks. Even if the contact of the sharp fuel cladding edge with the deformable annular member material is smooth enough to avoid a sensible damage to the seal, this contact may lead to contamination of the weld bead by elastomer particles. These particles involve defects (usually non-allowable porosities) of the further performed elding of said fuel cladding bead with the end plug (first or second plug).

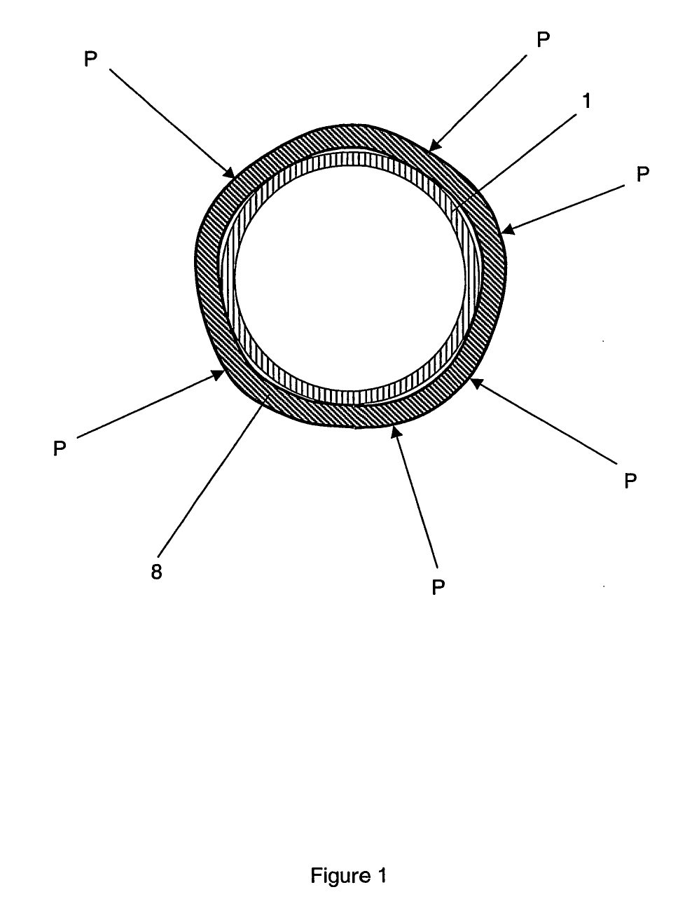

If the seal inner diameter is large enough to avoid the above drawbacks, he working of the deformable annular member and consequently its tightness is uestionable. Indeed the sealing cylindrical area of the seal is submitted to an external pressure. To the contrary of the deformation of a membrane submitted to internal pressure that is axisymmetrical and results from the strain of the membrane material, the deformation of a membrane submitted to external pressure can lead to unforeseeable deformation patterns (see FIG. 1) generated by folding of the membrane 8 instead of axisymmetrical shrinking around the cladding 1 under the external pressure P. The contact between the seal and the fuel cladding is therefore not perfect along the whole circumference and leaks may occur. These leaks involve the same consequences as those already described above.

Special precautions might be used to tighten the fabrication clearances of the fuel cladding and measures might be developed to enhance the alignment of the fuel cladding and seal centerlines. In such cases, one may hope that a compromise might be found to have a seal that is large enough to avoid undesirable contact during introduction of the fuel cladding but small enough to insure a leak tight contact between the seal and the fuel cladding while inflated from the outside. Such optimum is however not sustainable on the long term. A seal that is regularly experiencing pressure increases and subsequent pressure releases presents indeed a compression set phenomenon that involves a creep of the material and subsequent dimensional changes.

On the other hand, the applicant has been using inflatable seals that were presenting a rather short axial length of the cylindrical part that was limited by two end flanges or stiffeners. A short cylindrical length was intended to avoid undesirable deformation of this area that should have impeded a correct penetration of the fuel cladding through the non-inflated seal. With such a rigid cylindrical part, the tightness was only achieved when a sufficient pressure was applied to the seal. When the seal was submitted to an axial or to a circular movement, then the combinations of a contact extending along the whole seal length and of a sensible pressure involved that a phenomenon of stick and slip occurred. The tightness of the connection was impaired under such circumstances.

The deformable annular member shown in the figures attached to the above mentioned U.S. Pat. No. 4,748,798 patent that presents a rather long contact length with respect to its total length is also not suitable for axial movement of the fuel cladding because of the occurrence of a stick and slip phenomenon that might occur during cladding movement. This phenomenon would impair the seal tightness. To face this drawback, the inventor of said seal of the U.S. Pat. No. 4,748,798 patent has avoided the risk of stick and slip phenomenon by avoiding the need of a relative axial movement of the fuel cladding with respect to the sealing device. Such movement is not necessary thanks to the addition to the system of a supplementary bellow; the deformable annular member being moved with the fuel cladding itself. This solution is effective but requires supplementary pieces that are expensive, sensitive to fatigue and space consuming. A circular movement of the fuel cladding is not considered in this patent.

### BRIEF DESCRIPTION OF THE INVENTION

The device, object of the invention, avoids the drawbacks described above.

This sealing device between two media and the outer surface of a fuel cladding has three functional states:
a state retracted for contactless axial insertion of said fuel cladding through the sealing device,
a state statically hermetically sealed around said fuel cladding maintained at rest,
a state dynamically hermetically sealed around said fuel cladding under axial and/or rotational movement.

According to the invention, the sealing device also comprises:
a body crossed by a channel between an inlet aperture and an outlet aperture,
an elastomer tubular membrane, extending along said channel between said inlet and outlet apertures, this membrane having two end parts acting as leak tight attachment to said body, its inner diameter being, in free (non deformed) state, slightly smaller than the outer diameter of said fuel cladding,
a leak tight chamber located between the body and the elastomer membrane, and arranged so that the elastomer membrane may be deformed in the radial direction inwards into said chamber or outwards against the fuel cladding, a gas and vacuum supply system being provided in communication with said chamber to inflate or deflate the membrane.

Accordingly, the device of the invention, intended to seal the penetration of a fuel cladding into an enclosure that insures leak tightness while allowing rotational and axial movements, is based on the deformation of a deformable membrane shaped around the fuel cladding to seal. The main characteristics of this membrane are:
an axisymmetric shape with an inner diameter decreasing from the inlet to a minimum value at its midplane and increasing further to the outlet. In free state, the smaller diameter is slightly smaller than the outer diameter of the fuel cladding to seal,
a continuous main profile (without inflection points) and a rather large length to diameter ratio to enhance the sensitivity of modifying the area coming into contact with the fuel cladding as the pressure varies,
the applied pressure conditions are threefold; partial vacuum is used to retract the membrane towards its support piece leaving room for contactless fuel cladding penetration, pressure is used to assure leaktightness of the contact with the fuel cladding. A moderate pressure is applied to create a reduced contact area for allowing further axial and/or rotational movement of the fuel cladding while a higher pressure is used to insure a larger contact area and a more efficient leaktightness,
the membrane is mounted on a support piece to which it is fixed by two end flanges arranged in planes perpendicular to the membrane axis.

### DETAILED DESCRIPTION OF THE INVENTION

Other details and particular features of the invention will become apparent from the attached claims and from the description of the figures which are annexed to the present specification and which illustrate by way of a non-limitative example various embodiments of the invention.

The FIG. 1 shows in a cross-section a deformation pattern of a sealing membrane of the prior art, pressed around a cladding.

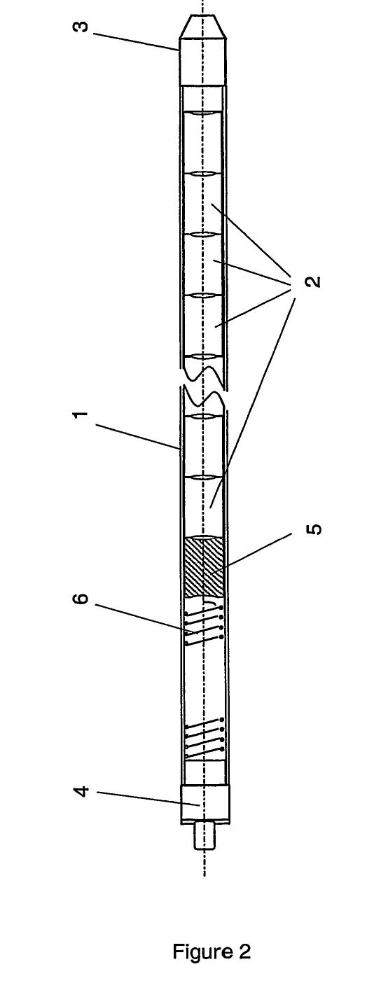

The FIG. 2 shows a typical fuel rod.

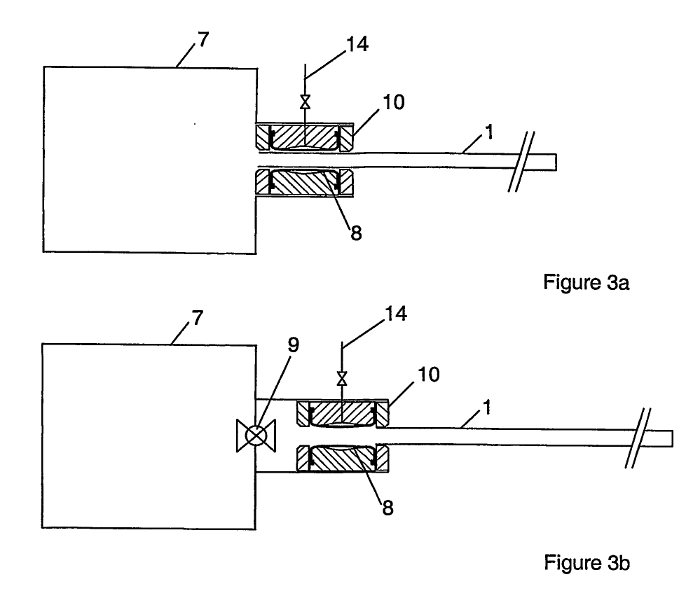

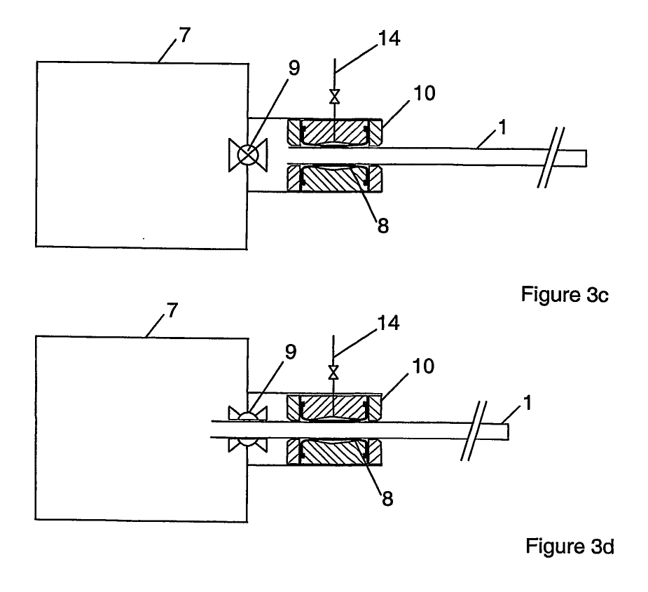

The FIG. 3 show schematically the general arrangement of the sealing device and of a fuel cladding:
FIG. 3a represents the case of a process enclosure;
FIG. 3b represents the case of a contaminated enclosure where a gaslock is provided by combining a valve and said sealing device;
FIG. 3c represents the situation where the fuel cladding is fully engaged into the sealing device but not in the valve;
FIG. 3d shows the situation where the fuel cladding is fully engaged through the gaslock (sealing device and valve).

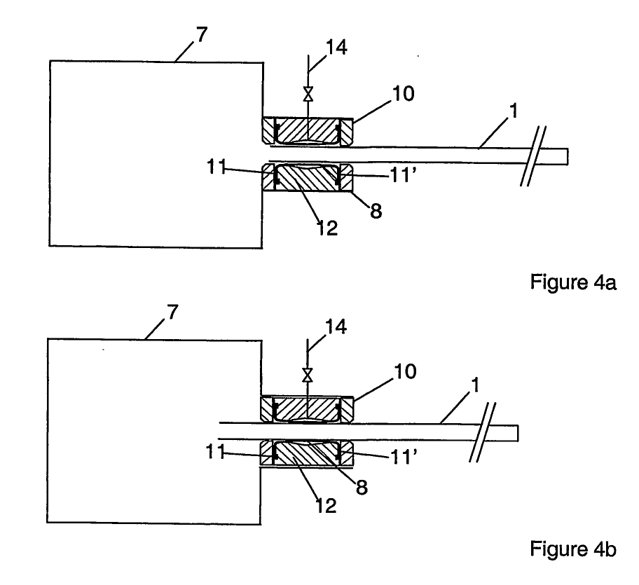

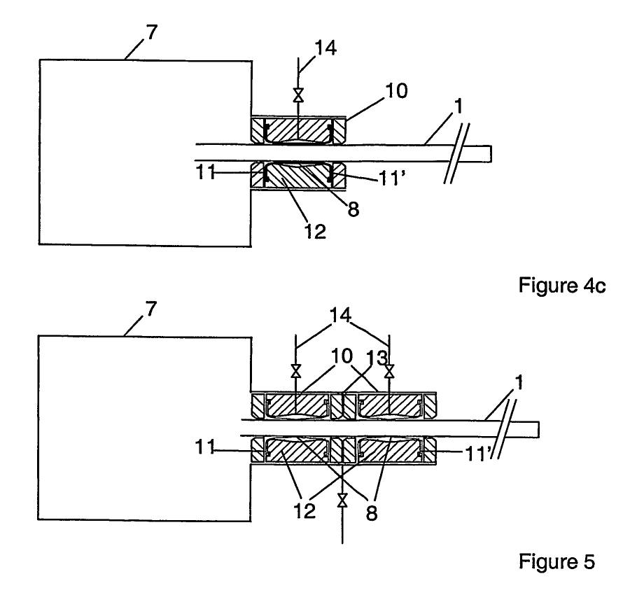

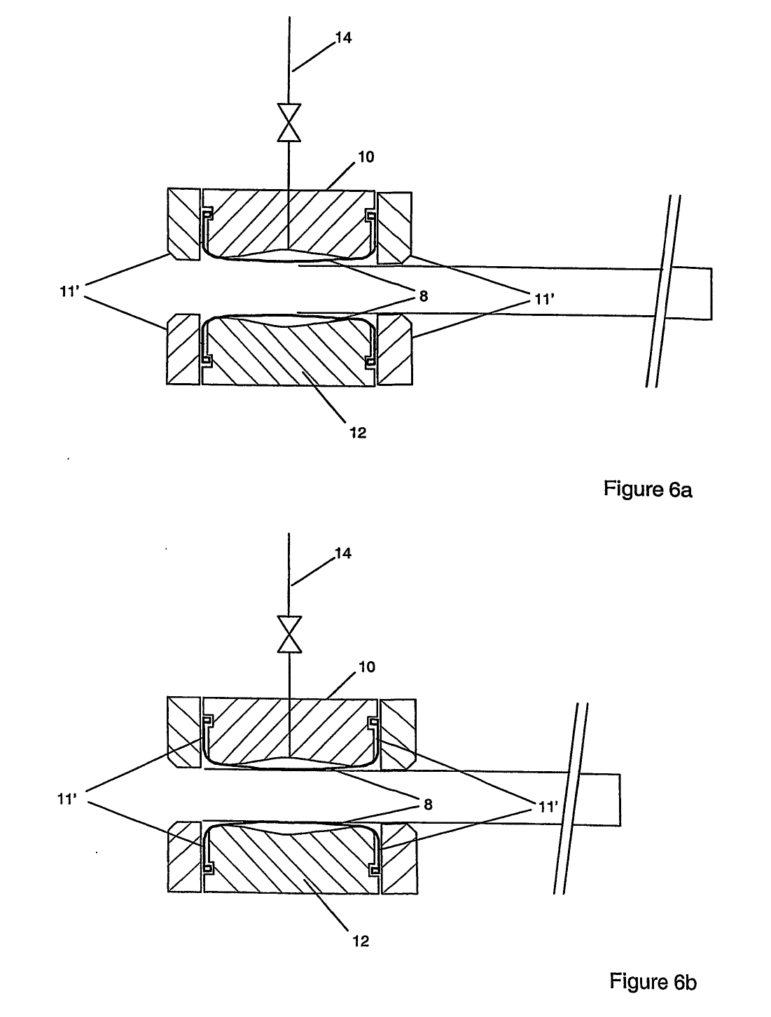

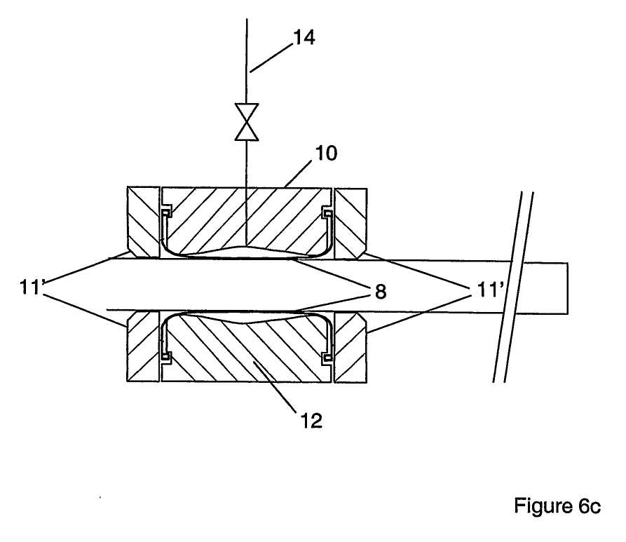

The FIGS. 4 and 6 represent schematically the membrane of the sealing device under different operating conditions when sealing a process enclosure:
FIG. 4a (with details in FIG. 6a) shows the membrane retracted by partial vacuum;
FIG. 4b (with details in FIG. 6b) shows the membrane inflated with a moderate pressure, contacting the fuel cladding;
FIG. 4c (with details in FIG. 6c) shows the membrane inflated with a higher pressure, contacting more efficiently the fuel cladding.

The FIG. 5 represents schematically an arrangement with two paired sealing devices.

In the different figures, the same reference numerals indicate identical or analogous elements.

The FIG. 2 shows the fuel cladding 1 already filled with fuel pellets and provided with the first and second plugs 3 and 4 respectively, to form a fuel rod. The FIG. 2 also shows two other inserts mentioned above, namely a blanket pellet 5 and a compression spring 6.

The FIG. 3a represents the case of a process enclosure i. e. when the enclosure 7 has to be tight only when a fuel cladding 1 is engaged in the enclosure. The tightness is insured by the contact of a membrane 8 with the fuel cladding 1. The FIG. 3a (with details in FIG. 6a) represents the membrane 8 retracted by partial vacuum through a gas system 14. When the fuel cladding 1 is not present there is no possibility to maintain a given atmosphere in the enclosure 7.

The FIG. 3b represents the situation of a contaminated enclosure or a process enclosure that has to remain tight between two consecutive process operations i. e. when the enclosure 7 has to be tight at any time and not only when a fuel cladding 1 to process is engaged. In that case, the tightness is obtained by the combination of a valve 9 and of said sealing device 10. The FIG. 3b (with details in FIG. 6a) represents the membrane 8 retracted by partial vacuum. As represented, a valve 9 is closed when the fuel cladding 1 is not engaged into the sealing device 10.

The FIG. 3c represents the situation where the fuel cladding 1 is engaged into the sealing device 10 and the correct pressure is applied to the membrane 8 insuring the enclosure tightness. The FIG. 3c (with details in FIG. 6b) represents the membrane 8 inflated with a moderate pressure. The valve 9 may then be opened to allow further axial movement of the fuel cladding 1 into the enclosure. Before opening the valve 9 one may take benefit of the tightness of the room comprised between the valve 9 and the sealing device 10 to evacuate the atmosphere of the fuel cladding 1 if the considered gas (usually air) is undesirable for the further process. The evacuation process of the fuel cladding 1 may be enhanced by one or several rinsing operations. The valve 9 has to be a ball valve type or similar allowing the direct passage of the fuel cladding 1.

The FIG. 3d represents the situation where the fuel cladding 1 has its end part engaged through both the sealing device 10 and the valve 9. The FIG. 3d (with details in FIG. 6c) represents the membrane 8 inflated with a higher pressure. The valve 9 is open allowing the fuel cladding 1 to be situated at any requested location in the enclosure 7.

As shown in the FIGS. 3 to 6, the membrane 8 itself is obtained by molding to obtain the desired shape. The two flanges 11, 11′ of the membrane 8 that are used to attach the membrane to the support 12 are obtained by molding of the membrane. The two flanges 11, 11′ of a membrane may have different sizes to acilitate the insertion of the membrane in its metallic support 12.

FIG. 4a (with details in FIG. 6a) shows the membrane 8 retracted by partial vacuum in the case of a process enclosure. This situation is used for allowing the fuel cladding 1 to be engaged in the sealing device 10. The membrane 8 is retracted so that it is maintained without contact with the engaging fuel cladding.

FIG. 4b (with details in FIG. 6b) shows the membrane 8 inflated with a moderate pressure in the case of a process enclosure. In that case its sealing surface is applied on the fuel cladding 1 so that a further movement (rotation or translation) is still possible. The applied pressure is such that the seal is tight but the force operating on the fuel cladding 1 is small enough to avoid impeding a fuel cladding movement.

FIG. 4c (with details in FIG. 6c) shows the membrane 8 inflated with a higher pressure in the case of a process enclosure. In that case the applied pressure is such that the seal is tight but the force operated on the fuel cladding impedes any fuel cladding movement.

FIG. 5 represents an arrangement with two paired sealing devices 10. The room 13 created between these two devices and the fuel cladding 1 itself is used either for injection of gas opposing to, or for vacuum collecting, any possible leak issued from the considered enclosure 7.

In such case it is possible to connect the room 13 between the two devices 10 to analyze the atmosphere and to control if there is any leak of the system. On the other hand it is also possible to apply to the room 13 between the two devices 10, a pressure that is larger than the pressure existing in the enclosure 7 to seal. This pressure causes an inward flow towards the enclosure 7 instead of an outward leak should the inner seal be deficient.

Instead of gas injection mentioned above, the room 13 may be used to collect any possible leak and analyze his nature.

Some non-limiting parameters of the device 10 for sealing the outer surface of a fuel cladding 1 are given hereafter:
the membrane 8 is made out of elastomer material,
the device may also be used to insure the tightness of any enclosure with a fuel cladding even if the latter is not filled or meant to be filled with nuclear fuel material,
the device may also be used to insure the tightness of any enclosure with a fuel rod (i. e. a fuel cladding filled with nuclear material and equipped with the two end plugs 3 and 4). Such case may be useful for further processing of the fuel rod like pressurizing, reworking, repairing or any other processing requesting a leak tight connection with the process enclosure.

As shown in the drawings and during introduction of the fuel cladding 1, the membrane 8 is submitted to partial vacuum and, consequently, it is retracted towards the support piece 12. In such situation room is given to the fuel cladding 1 allowing a contactless introduction into the sealing device.

Once the fuel cladding 1 is introduced, the partial vacuum retracting the membrane 8 is replaced by a pressure that is chosen as function of the operating conditions of the sealing device 10.

Should the connection be used under static conditions (no movement of the fuel cladding), a rather large pressure may then be applied. In this condition, the contact surface between the membrane 8 and the fuel cladding 1 is maximized, increasing the seal tightness. As the nominal inner diameter of the membrane 8 is, in free state, somewhat smaller than the outer diameter of the fuel cladding 1, there is neither shrinkage of the contact surface nor risk of folding occurrence with associated leaks. Only the force by which the seal is applied onto the fuel cladding 1 is influenced by the pressure, not the inner seal diameter.

If the sealing device 10 is used while the fuel cladding 1 is moving either in rotation or axially, the applied pressure is reduced to allow the required displacement. The contact surface between the membrane 8 and the fuel cladding 1 is somewhat reduced but the tightness can always be insured.

During axial or circular movement, the pressure is lowered accordingly decreasing the force operated by the membrane 8 on the fuel cladding 1. As the membrane 8 is rather thick and robust, stick and slip phenomena are avoided.

It has to be understood that the invention is in no way limited to the described embodiments and that many modifications can be applied thereto without leaving the scope of the present invention.

The applicant has experienced such kind of sealing device 10 in his MOX fabrication plant and more particularly with devices where the membrane 8 is made out of molded silicone rubber with a Shore hardness of 60° and submitted to the following operating conditions:
partial vacuum: about −500 mbar
moderate pressure: from 200 to 400 mbar
higher pressure: from 800 to 1,200 mbar.

The fabrication tolerance imposed to the inner membrane diameter is such that its inner diameter in free state is equal to the diameter of the considered fuel cladding minus 0.3 to 0.6 mm while the membrane is retracted by about 1 mm when submitted to a partial vacuum.

1-4. (canceled)

5. Sealing device (10) intended for providing a sealing between an aperture of an enclosure (7) and the outer surface of a nuclear fuel rod cladding (1) inserted through said aperture, wherein said sealing device comprises a retractable and inflatable member having three states:
a state retracted for contactless insertion of said nuclear fuel rod cladding (1) through the aperture,
a state inflated at a moderate pressure for providing said sealing while enabling axial and/or rotational movement of said nuclear fuel rod cladding, and
a state inflated at a higher pressure for providing said sealing while said nuclear fuel rod cladding is at rest.

6. The sealing device as claimed in claim 5, comprising a support (12) crossed by a channel extending between an inlet and an outlet of said aperture, for allowing insertion of said nuclear fuel rod cladding, said retractable and inflatable member comprising an elastomer tubular membrane (8), extending along said channel, this membrane (8) having two end parts acting as leak tight attachment to said support (12), its inner diameter being, in free state, slightly smaller than the outside diameter of said fuel cladding (1), and said sealing device further comprises a leak tight chamber located between the support (12) and the elastomer tubular membrane (8), and arranged so that the elastomer tubular membrane may be deformed in the radial direction inwards into said chamber or outwards against the nuclear fuel rod cladding (1), a gas supply system (14) being provided to inflate or deflate the membrane (8).

7. The sealing device as claimed in claim 6, wherein the elastomer tubular membrane (8) is sized so that, in free state, said membrane is in leak tight sliding contact with said nuclear fuel rod cladding (1) for axial and/or rotational nuclear fuel rod cladding movement.

8. The sealing device as claimed in claim 6, wherein the elastomer tubular membrane (8) presents an axial inner section that, in free state, is decreasing from one end to its midplane and increasing towards its second end.

9. The sealing device as claimed in claim 7, wherein the elastomer tubular membrane (8) presents an axial inner section that, in free state, is decreasing from one end to its midplane and increasing towards its second end.
